(19) United States
(12) Patent Application Publication
(10) Pub. No.: US 2018/0192461 A1
(43) Pub. Date: Jul. 5, 2018

(54) METHOD AND DEVICE FOR CONNECTING NON-3GPP OR NON-IP DEVICE TO LTE-BASED COMMUNICATION SYSTEM

(71) Applicant: Industrial Technology Research Institute, Hsinchu (TW)

(72) Inventors: Rohit Naik, Hsinchu City (TW); Shubhranshu Singh, Hsinchu City (TW); Ying-Yu Chen, Hsinchu County (TW)

(73) Assignee: Industrial Technology Research Institute, Hsinchu (TW)

(21) Appl. No.: 15/849,615

(22) Filed: Dec. 20, 2017

Related U.S. Application Data
(60) Provisional application No. 62/442,445, filed on Jan. 5, 2017.

(51) Int. Cl. H04W 76/14; H04W 8/24; H04W 92/18; H04W 8/00; H04W 28/02

(52) U.S. Cl. CPC H04W 76/14; H04W 8/24; H04W 88/04; H04W 8/005; H04W 28/0215; H04W 92/18

(57) ABSTRACT

The disclosure provides a method of connecting a non-3GPP or a non-IP device to a LTE-based communication system and related apparatuses using the same. In an aspect, the method would include not limited to determining radio interfaces supported by the relay; configuring a broadcast message to be transmitting by including information related to radio interfaces supported by the relay in the broadcast message; transmitting the broadcast message on all radio channels associated with the radio interfaces supported by the relay; and processing a Layer 2 connection request.

### CROSS-REFERENCE TO RELATED APPLICATION

This application claims the priority benefit of U.S. provisional application Ser. No. 62/442,445, filed on Jan. 5, 2017. The entirety of the above-mentioned patent application is hereby incorporated by reference herein and made a part of this specification.

### TECHNICAL FIELD

The disclosure is directed to a method of connecting a non-3GPP or a non-IP device to a LTE-based communication system and related apparatuses using the same.

### BACKGROUND

The disclosure defines various phrases and terms as follows. A remote user equipment (UE) in this disclosure would refer to an electronic device which could be capable of device to device (D2D) communication with one or more electronic devices, may intend to perform D2D communication with one or more electronic devices, and may request for an authorization from a network for D2D communication. D2D communication in this disclosure could be used synonymously with ProSe communication. A UE-to-network relay refers to a network node which is connected to the network and would provide a network access to the remote UE. A ProSe function refers to a network node which is responsible for the authorization and service control for the D2D or ProSe communication. A service capability exposure function (SCEF) refers to a network function that provides a means to securely expose the services and capabilities provided by 3GPP network interfaces. The definition of a non-IP based data delivery (NIDD) mechanism is provided in 3GPP technical specification (TS) 23.682. Other terms and definitions that could be relevant to this disclosure could be provided by TS 23.303 which is incorporated by reference.

There is an ongoing endeavor in 3GPP to continuously enhance the capability of a ProSe UE-to-network relay such as by enhancing the ProSe UE-to-network relay functionalities to be capable of handling various commercial usage scenarios. A generic UE-to-network relay architecture that supports wearable devices as shown in FIG. 1. The UE-to-network relay architecture of FIG. 1 may include a network node 101, a relay UE 102, and a remote UE 103. The wireless communication among multiple relay UEs 102 such as among two relay UEs (between two 102's) would utilize Long Term Evolution (LTE) wireless connections, whereas communications between relay UE 102 and relay UE 103 would utilize a Bluetooth or a Wi-Fi connection (P101).

FIG. 2 illustrates a hypothetical UE-to-network relay architecture that supports Internet of Things (IoT) in a 5G communication system. The UE-to-network relay architecture could be enhanced to support various functions including providing a coverage hole (S1), extending the network coverage to an isolated area (S2), adapting user devices or mobile stations (MS) to function as relays (S3), providing multi-hop relaying (S4), mitigating effects of shadowing (S5), extending the network coverage (S6) at cell edge, and etc. The current state of the art mechanism of a UE-to-network relay architecture has been described in 3GPP ProSe specification TS 23.303 which defines how a UE-to-network relay node would operate at the Layer 3. The UE-to-network relay node could be primarily responsible for providing generic functions and could also relay any LTE-based uplink (UL) and downlink (DL) traffic between a Remote UE and the network.

Currently Non 3GPP devices cannot connect to a LTE core network to obtain a D2D Authorization. Further, many machine type communication (MTC) and CIoT devices may not support the Internet Protocol (IP) layer. However, in order for these devices to perform D2D communication, these devices would still need to connect to the core network and obtain authorization for D2D communication. In existing network standards, it may not be possible for a MTC device or a CIoT device to connect to the core network and obtain authorization for network access because the existing network standards would only support IP based communication. Both non 3GPP and non-IP devices may still require an anchoring node to provide them with a network access. For the commercial use cases all such devices will need a network access, but the network currently may not support Layer-2 non-3GPP or non-IP devices which could be important for commercial deployments.

FIG. 3 shows existing IP based UE-to-network relay solution according to 3GPP technical release 12/13. In the current technical specification of LTE release 12/13, a UE-To-network relay node would act as a DHCP node and would assign an IP address received from the network to a remote UE. The remote UE would then use the IP address to communicate with the network via the relay node. However, this means that non-IP devices could not be supported. Moreover, many of the low cost MTC devices such as IOT devices may not support IP communication, and other wearable type of devices may support non-3GPP access mechanism which may include Zigbee, Bluetooth, and WiFi. All these devices would still need the network connectivity and authentication procedure from the core network to perform direct D2D communication. For the commercial use case, these could constitute critical limitations among existing solutions since non-IP and non-3GPP devices would have difficulties connecting to the network. Thus, there is currently no provision to support network connectivity for such Non-IP and non-3GPP MTC devices that have interfaces such as Zigbee, WiFi, Bluetooth, and so forth.

### SUMMARY OF THE DISCLOSURE

Accordingly, the disclosure is directed to a method of connecting a non-3GPP or a non-IP device to a LTE-based communication system and related apparatuses using the same.

In an aspect, the disclosure is directed to a method used by a relay to connect a non-3GPP or a non-IP device to a LTE-based communication system f. The method would include not limited to: determine radio interfaces supported by the relay; configure a broadcast message to be transmitted by including information related to radio interfaces supported by the relay in the broadcast message; transmit the broadcast message on all radio channels associated with the radio interfaces supported by the relay; and process a Layer 2 connection request for a Layer 2 connection.

In an aspect, the disclosure is directed to a relay which includes not limited to: a wireless transceiver and a processor connected to the transceiver. The processor is configured at least to: determine radio interfaces supported by the relay; configure a broadcast message to be transmitted by including information related to radio interfaces supported by the relay in the broadcast message; transmit the broadcast message on all radio channels associated with the radio interfaces supported by the relay; and process a Layer 2 connection request for a Layer 2 connection.

In an aspect, the disclosure is directed to a method used by a non-3GPP or a non-IP user equipment to connect to a LTE-based communication system. The method would include not limited to: receiving through a radio interface a broadcast message which comprises information related to radio interfaces supported by a relay; obtaining from the broadcast message the information related to the plurality of radio interfaces supported by the relay; matching the information related to the plurality of radio interfaces supported by the relay with a network selection criteria of the UE; and selecting from the plurality of radio interfaces one radio interface that matches the network selection criteria of the UE.

In an aspect, the disclosure is directed to a user equipment which would include not limited to: a transceiver; and a processor coupled to the transceiver and configured to: receive through a radio interface a broadcast message which comprises information related to radio interfaces supported by a relay; obtain from the broadcast message the information related to the plurality of radio interfaces supported by the relay; match the information related to the plurality of radio interfaces supported by the relay with a network selection criteria of the UE; and select from the plurality of radio interfaces one radio interface that matches the network selection criteria of the UE.

In order to make the aforementioned features and advantages of the disclosure comprehensible, exemplary embodiments accompanied with figures are described in detail below. It is to be understood that both the foregoing general description and the following detailed description are exemplary, and are intended to provide further explanation of the disclosure as claimed.

It should be understood, however, that this summary may not contain all of the aspect and embodiments of the disclosure and is therefore not meant to be limiting or restrictive in any manner. Also the disclosure would include improvements and modifications which are obvious to one skilled in the art.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 illustrates a generic UE-to-network relay architecture that would support a wearable device according to LTE release 14/15.

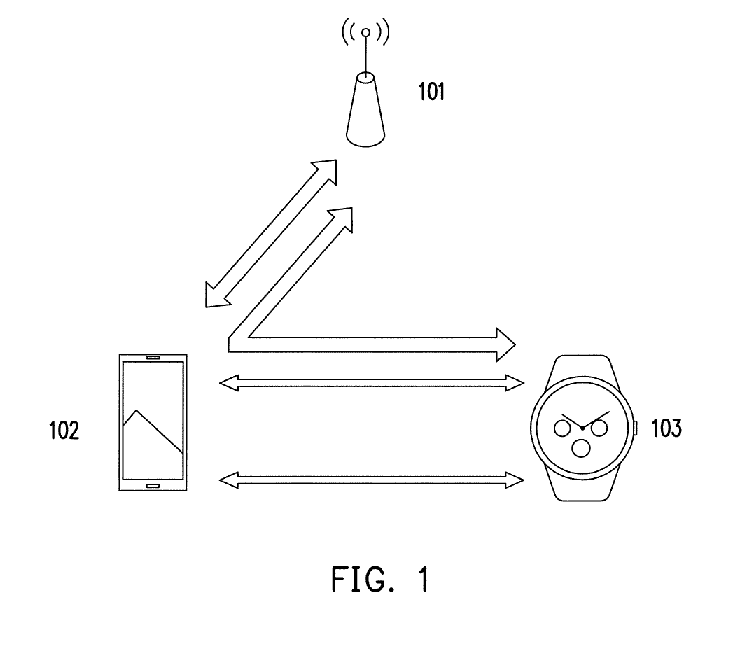

FIG. 2 illustrates a hypothetical UE-to-network relay architecture that supports IoT in a 5G communication system.

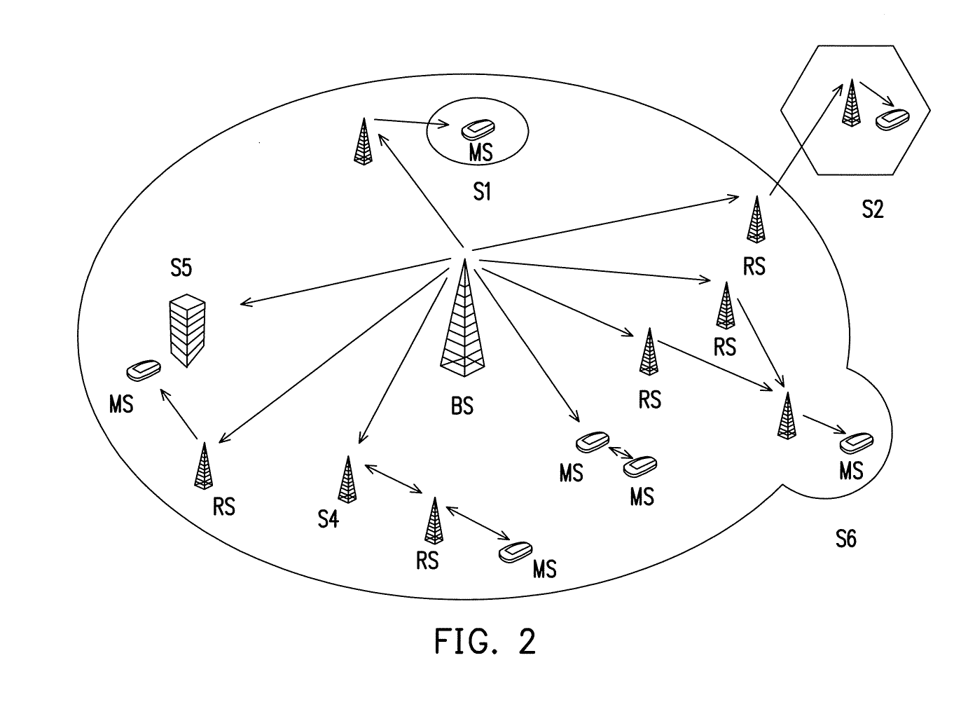

FIG. 3 illustrates an existing IP based UE-to-network relay solution as per 3 GPP release 12/13.

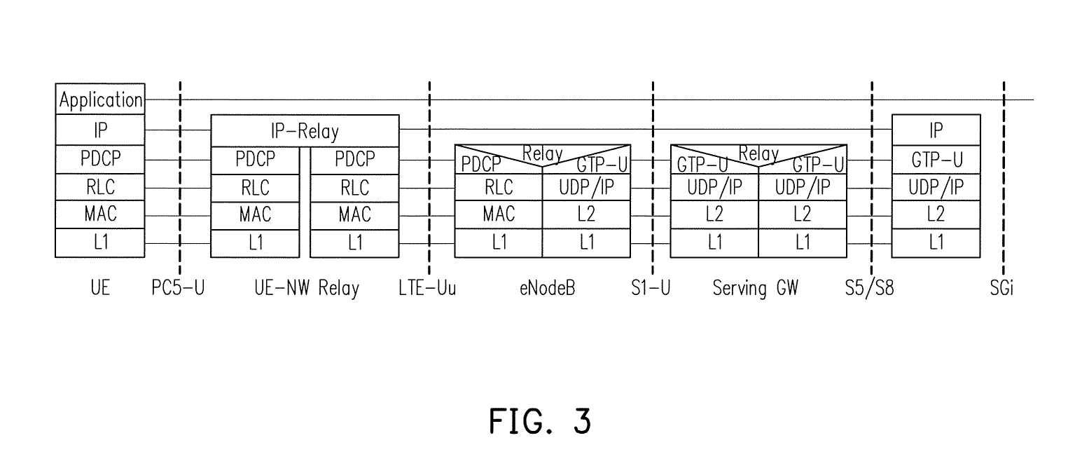

FIG. 4A is a flow chart which illustrates a method used by a relay to connect a non-3GPP or a non-IP device to a LTE-based communication system in accordance with one of the exemplary embodiments of the disclosure.

FIG. 4B illustrates a method used by a non-3GPP or a non-IP user equipment to connect to a LTE-based communication system in accordance with one of the exemplary embodiments of the disclosure.

FIG. 5 illustrates a network architecture in terms of a high level functional block diagram in accordance with one of the exemplary embodiments of the disclosure.

FIG. 6 shows a signaling diagram for connection establishment and network authentication of non-3GPP devices in accordance with one of the exemplary embodiments of the disclosure.

FIG. 7 shows a signaling diagram for connection establishment and network authentication of non-IP devices in accordance with one of the exemplary embodiments of the disclosure.

FIG. 8 illustrates a protocol structure for non-3GPP and non-IP devices in accordance with one of the exemplary embodiments of the disclosure.

### DETAILED DESCRIPTION OF DISCLOSED EMBODIMENTS

Reference will now be made in detail to the present exemplary embodiments of the disclosure, examples of which are illustrated in the accompanying drawings. Wherever possible, the same reference numbers are used in the drawings and the description to refer to the same or like parts.

As previously described, the currently known communication system may suffer from the following difficulties. First, non-3GPP devices such as devices with Zigbee, WiFi, and Bluetooth interface may not be able to connect with the LTE core network to obtain a network authorization for device to device (D2D) connectivity. Second, many of the MTC and CIoT devices may not support the IP layer. If these devices need to perform D2D communication, then these devices may still require network connectivity and obtaining network authorization. In existing solutions, obtaining network authorization might not be possible since the network access is only IP based. Third, both the non-3GPP and non-IP devices may require an anchoring node to provide them with a network access. For the commercial use cases, all such devices will still require a network access. Therefore, the disclosure provides a solution to address these requirements.

The main objectives of the disclosure would include providing a solution which utilizes a LTE network to facilitate proximity based services (i.e. D2D or ProSe) to non-3GPP devices over a LTE network. The disclosure would also aim to providing a solution which utilizes a LTE network to facilitate proximity based services to non-IP devices that may or may not have LTE interfaces.

The disclosure would allow non-3GPP devices to utilizes a LTE network to facilitate proximity based services via at a UE-to-Network relay or multiple relays, and such mechanism may include not limited to: the relay requesting a packet data network (PDN) connection from the network on behalf of a remote UE. Next, the relay would support the functionality of translating received remote-UE layer 2 request toward the network by using the PDN connection, and vice versa. Next, the relay would register, authenticate, and authorize remote non-3GPP devices having ProSe capability with the LTE core network.

The disclosure would allow non-IP devices to utilizes a LTE network to facilitate proximity based services via a UE-to-network relay or multiple UE-to-network relays, and such mechanism may include not limited to: using a new IP type or using a representational state transfer (RESTful) application protocol interface (API) between a service capability exposure function (SCEF) and a ProSe Function. Next, the SCEF would map the ProSe function messages over a non-IP PDN and forward the ProSe function messages to the relay function.

The disclosure would provide a mechanism by which a UE-to-network relay may advertise its capabilities to a remote UE, and such mechanism may include not limited to: the relay adding all the supported bearer details (3GPP and Non-3GPP bearers) in the broadcast advertisement message to indicate its capabilities. If the UE-to-network relay would support LTE, WiFi, and BT bearers, then the broadcast advertisement message will include all three bearers as supported bearers. Next, the UE-to-network relay would broadcast this advertisement message on all supported radio bearers including 3GPP and Non-3GPP bearers. This further means that if the UE-to-network relay would support LTE, WiFi and BT bearer, the advertisement message will be broadcasted on all three bearers.

The disclosure would provide a mechanism by which a remote UE can choose a radio bearer to connect with a relay UE, and such mechanism may include not limited to: the remote UE receiving the broadcast advertisement message on its current listening bearer, the remote UE filters the supported bearer details of the relay UE from its broadcast advertisement message. The remote UE would then match the previously filtered supported bearer details of the relay UE with its own supported bearers and select one of the bearer based on its own network selection criteria such as power consumption, bandwidth requirement, and size of data to establishing the L2 connection with the relay UE.

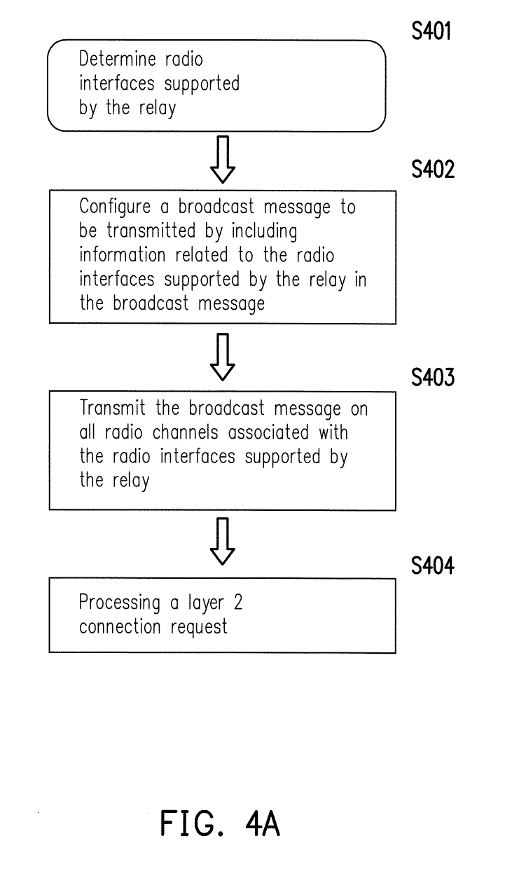

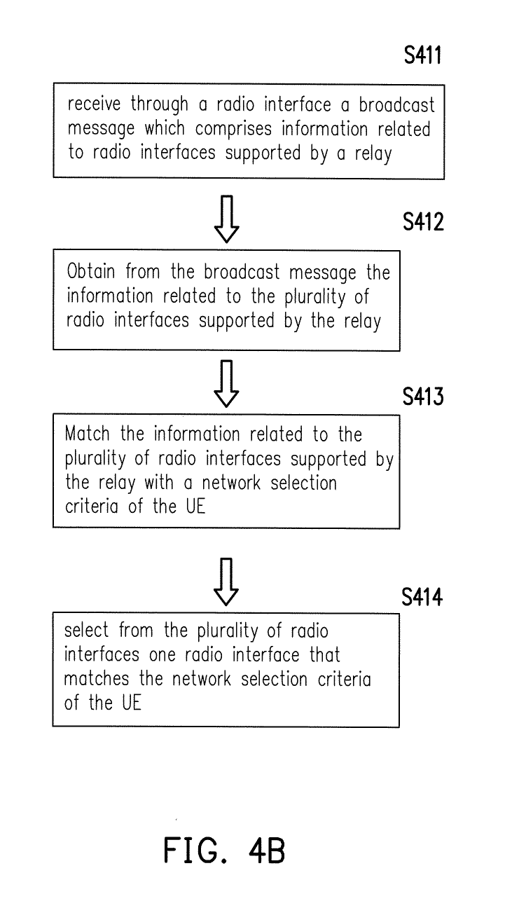

FIG. 4A is a flow chart which illustrates a method used by a relay to connect a non-3GPP or a non-IP device to a LTE-based communication system in accordance with one of the exemplary embodiments of the disclosure. In step S401, the relay would determine radio interfaces supported by the relay. In step S402, the relay would configure a broadcast message to be transmitted by including information related to radio interfaces supported by the relay in the broadcast message. In step S403, the relay would transmit the broadcast message on all radio channels associated with the radio interfaces supported by the relay. In step S404, the relay would process a Layer 2 connection request for a Layer 2 connection.

The above described radio interfaces may include a radio bearer, and information related to the radio interfaces may include capabilities associated with the radio bearer of the radio interfaces. If the supported radio bearers are a LTE bear, a Wi-Fi bear, and a BT bearer, and then the broadcast message would include all three of the LTE bearer, the Wi-Fi bearer, and the BT bearer in the information related to the radio interfaces.

The Layer 2 connection request may include an identification (ID), a service request, and a device type. The device type is either a non-3GPP device type or a non-IP device type.

The relay may further transmit a PDN connection request on behalf of a remote user equipment (UE). The relay may perform a translation of the Layer 2 request received from the UE by using the PDN connection. The relay may receive an Internet Protocol (IP) address from a network for the remote UE. The above described PDN connection request could be a PDN connection for a non-3GPP type of remote UE, and the PDN connection request could be a non-IP PDN connection for a non-IP type of remote UE.

The relay may transmit an authentication request to a ProSe function on behalf of the remote UE. The relay may grant a Layer 2 connection request after the authentication request is successful. The relay may transmit a Layer 2 connection accept message which would include a D2D configuration for the remote UE. Alternatively, the relay may transmit a Layer 2 connection denied message after the authentication request is revoked and subsequently sever the Layer 2 connection with the Remote UE. The relay may maintain a mapping relationship between the Layer 2 connection and the IP address until the layer 2 connection is ended.

The hardware of the relay may include at least but not limited to a wireless transceiver; and a processor connected to the transceiver. The processor would be configured to implement the above described method including determine radio interfaces supported by the relay, configure a broadcast message to be transmitted by including information related to radio interfaces supported by the relay in the broadcast message, transmit the broadcast message on all radio channels associated with the radio interfaces supported by the relay, and process a Layer 2 connection request for a Layer 2 connection.

FIG. 4B illustrates a method used by a non-3GPP or a non-IP user equipment to connect to a LTE-based communication system in accordance with one of the exemplary embodiments of the disclosure. In step S411, the UE would receive through a radio interface a broadcast message which would include information related to radio interfaces supported by a relay. In step S412, the UE would obtain from the broadcast message the information related to the plurality of radio interfaces supported by the relay. In step S413, the UE would match the information related to the plurality of radio interfaces supported by the relay with a network selection criteria of the UE. In step S414, the UE would select from the plurality of radio interfaces one radio interface that matches the network selection criteria of the UE.

The above described radio interfaces may include a radio bearer, and information related to the radio interfaces comprise capabilities associated with the radio bearer of the radio interfaces. If the radio interfaces include a LTE bear, a Wi-Fi bear, and a BT bearer, then the broadcast message includes all three of the LTE bearer, the Wi-Fi bearer, and the BT bearer in the information related to the radio interfaces.

The UE would further transmit a Layer 2 connection request for a Layer 2 connection, and the Layer 2 connection request would include an identification (ID) of the UE, a service request, and a device type. The device type is either a non-3GPP device type or a non-IP device type. The UE would further receive a Layer 2 connection accept message may include comprise a D2D configuration for the UE. The UE would receive a Layer 2 connection denied message after an authentication request is revoked as the Layer 2 connection is severed by a relay.

The hardware of the user equipment may include at least but not limit to a transceiver and a processor coupled to the transceiver. The processor is configured to implement the above describe method of the UE including receive through a radio interface a broadcast message which comprises information related to radio interfaces supported by a relay, obtain from the broadcast message the information related to the plurality of radio interfaces supported by the relay, match the information related to the plurality of radio interfaces supported by the relay with a network selection criteria of the UE, and select from the plurality of radio interfaces one radio interface that matches the network selection criteria of the UE.

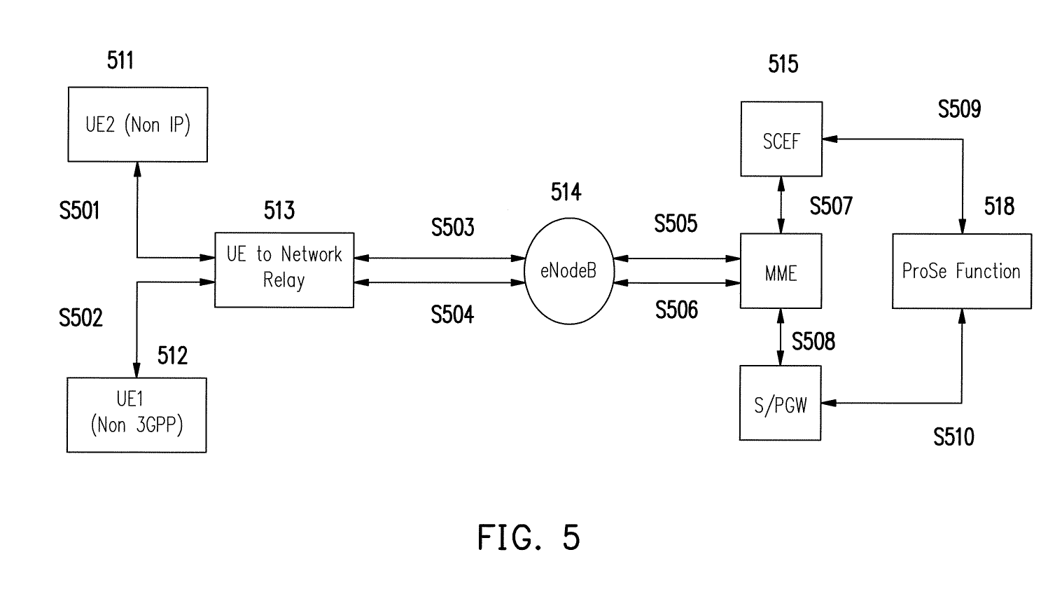

FIG. 5 illustrates a network architecture for implementing the disclosed method of connecting a non-3GPP or a non-IP device to a LTE-based communication system with related apparatuses in terms of a high level functional block diagrams. The network architecture would include not limited to a UE-to-network relay 513 which connect at least one non-IP UE 511 or at least one non-3GPP UE 512 to an eNB 514 located in a radio access network. The eNB 514 would communicate with the MME 516 of a core network. In step S501, the UE-to-network relay 513 would broadcast or transmit a message which contains information that advertises the UE-to-network relay 513's capabilities to the at least one non-IP UE 501. In step S502, the same message would also be received by the at least one non-3GPP UE 512. The information may include what services are provided by the UE-to-network relay 513 and what radio interfaces are supported by the UE-to-network relay 513. Such message could be broadcasted on all radio interfaces that are supported by the UE-to-network relay 511. After the at least one non-IP UE 511 or at least one non-3GPP UE 512 receives this broadcasted message which contains such advertisement, the at least one non-IP UE 511 or at least one non-3GPP UE 512 may establish a Layer 2 connection with the UE-to-network relay 513 on a radio interface which is selected by the at least one non-IP UE 511 or at least one non-3GPP UE 512.

While establishing the Layer 2 connection, the non-IP UE 501 may transmit a D2D Service Request message which indicates that the non-IP UE 501 intends to engage in a D2D communication, may provide an identification (ID) of the non-IP UE 501, and may indicate a device type of non-IP within the Layer 2 link. Based on the device type, the UE-to-network relay 513 will request for the PDN connection with the core network. For the non-IP devices, the UE-to-network relay 513 will request Non-IP PDN. Similarly, while establishing the Layer 2 connection, the non-3GPP UE 502 may transmit a D2D Service Request message which indicates that the non-3GPP UE 502 intends to engage in a D2D communication, may provide an identification (ID) of the non-3GPP UE 502, and may indicate a device type of non-3GPP within the Layer 2 link. Based on the device type, the UE-to-network relay 513 will request for the PDN connection with the core network. For the non-3GPP devices, the UE-to-network relay 513 will request for a PDN connection.

Next, the UE-to-network relay 513 in step S503 may transmit a non-IP PDN request on behalf of the non-IP UE 501 to the eNB 514. In step S504, the UE-to-network relay 513 may transmit a PDN request on behalf of the non-3GPP UE 502 to the eNB 514. In step S505, the eNB 514 may transmit the non-IP PDN request on behalf of the non-IP UE 501 to the MME 516. In step S506, the eNB 514 may transmit the non-3GPP PDN request on behalf of the non-3GPP UE 502 to the MME 516. In step S507, the MME 516 may interact with the SCEF 515 through the NIDD interface to process the non-IP PDN request. In step S508, the MME 516 may interact with the service gateway or packet gateway (S/PGW) 517 to process non-3GPP PDN request. In step S509, a new interface of IP/Restful AP1 is proposed between SCEF 515 and ProSe function 518 to process non-IP user devices. In step S510, the IP interface is used between the S/PGW 517 and the ProSe function 518 to process non-3GPP user devices. The UE-to-network relay 513 will perform translations between the Layer 2 link and the IP/non-IP PDN link with the network.

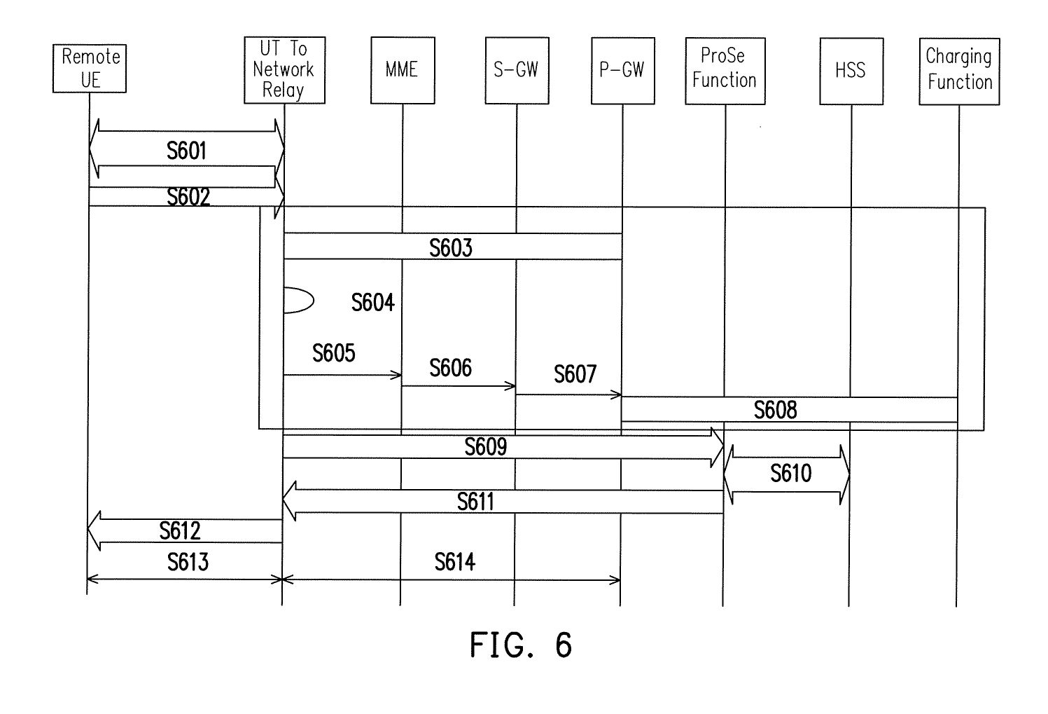

FIG. 6 shows a signaling diagram for connection establishment and network authentication of non-3GPP devices in accordance with one of the exemplary embodiments of the disclosure. In step S601, the UE-to-network relay would determine all access networks which the UE-to-network relay would support. The supported network may include both 3GPP and non-3GPP access networks. The UE-to-network relay would broadcast or transmit an advertisement message by using a Layer2 broadcast mechanism. The advertisement message could be broadcasted on all the access networks supported by the UE-to-network relay, and the content of the advertisement message may include what all services & radio interfaces which are supported by the UE-to-network relay. In step S602, the non-3GPP remote UE would receive this broadcast message over the access network which is being used by the non-3GPP remote UE, and the UE-to-network relay would subsequently transmit a Layer 2 connection request to the non-3GPP remote UE on a radio interface selected by the non-3GPP remote UE. In response to receiving the Layer 2 connection request, the non-3GPP remote UE would transmit to the UE-to-network relay the ID of the non-3GPP remote UE, the required services, and the device type of the non-3GPP remote UE.

In steps S603-S608, the UE-to-network relay will allocate the ID address for the non-3GPP remote UE and will inform this IP and user ID to the network and charging function to charge the non-3GPP remote UE for this data. In step S603, the UE-to-network relay would establish the PDN connection with the network on behalf of the non-3GPP remote UE. Through the PDN connection, a packet gateway (P-GW) would allocate and inform the IP address for the non-3GPP remote UE and would inform the IP address to the UE-to-network relay. In step S604, the UE-to-network relay would maintain the mapping between the L2 link with the non-3GPP remote UE and the IP address allocated by the network. The UE-to-network relay would also perform the message translation from the L2 link toward the network by using this IP address. In step S605, the UE-to-network relay would transmit a remote UE report which would include the ID and IP information of the non-3GPP remote UE to the MME. In step S606, the MME would forward the remote UE report to the S-GW. In step S607, the S-GW would forward the remote UE report to the P-GW. In step S608, the charging function would use this IP address contained in the remote UE report to charge the non-3GPP remote UE and not the relay.

In step S609, the UE-to-network relay would forward the D2D authorization request from the non-3GPP remote UE to the ProSe function by transmitting to the ProSe function an Authorization Request message which would include an ID of the non-3GPP remote UE and information related to the D2D service request. In step S610, the ProSe function will check the authentication with the home subscriber server (HSS). If the authorization is successful, the ProSe function will accept the non-3GPP remote UE for D2D communication. In step S611, the ProSe function would provide configuration details related to the D2D communication by transmitting configuration parameters to the UE-to-network relay. In step S612, the UE-to-network relay would transmit to the non-3GPP remote UE a Layer 2 connection accept message which would include configuration parameters for the D2D communication. In step S612, the UE-to-network relay would maintain a Layer 2 communication link with the non-3GPP remote UE. In step S613, the UE-to-network relay would relay IP based data traffic on behalf of the non-3GPP remote UE.

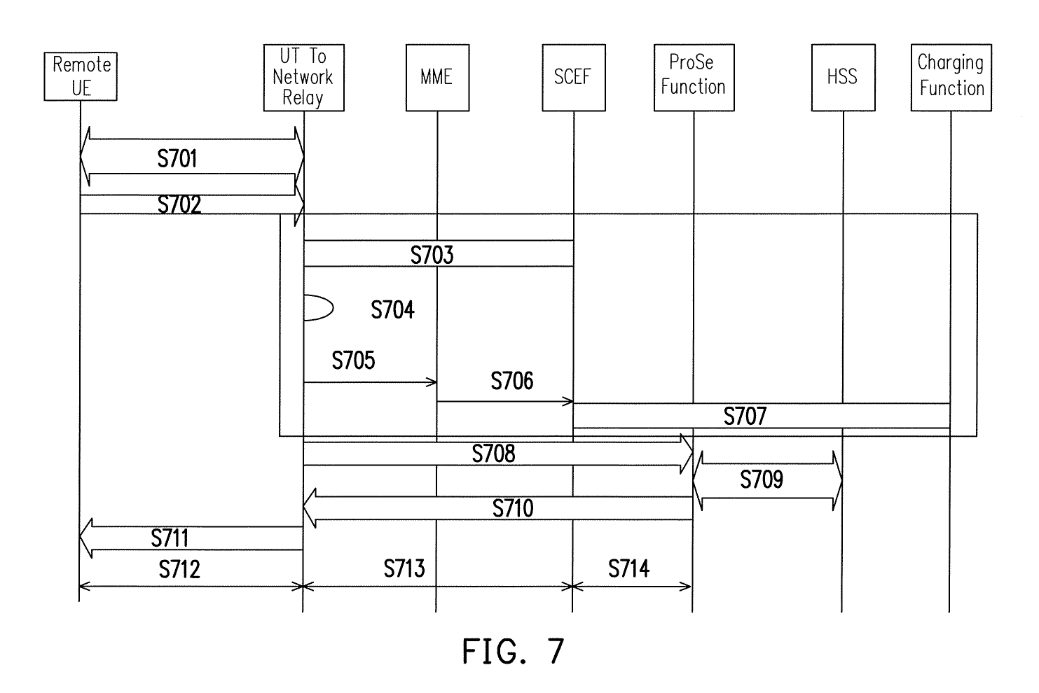

FIG. 7 shows a signaling diagram for connection establishment and network authentication of non-IP devices in accordance with one of the exemplary embodiments of the disclosure. In step S701, the UE-to-network relay would determine all access networks which the UE-to-network relay would support. The supported network may include both 3GPP and non-3GPP access networks. The UE-to-network relay would broadcast or transmit an advertisement message by using a Layer2 broadcast mechanism. The advertisement message could be broadcasted on all the access networks supported by the UE-to-network relay, and the content of the advertisement message may include what all services & radio interfaces which are supported by the UE-to-network relay. In step S702, the non-IP remote UE would receive this broadcast message over the access network which is being used by the non-IP remote UE, and the UE-to-network relay would subsequently transmit a Layer 2 connection request to the non-IP remote UE on a radio interface selected by the non-IP remote UE. In response to receiving the Layer 2 connection request, the non-IP remote UE would transmit to the UE-to-network relay the ID of the non-IP remote UE, the required services, and the device type of the non-3GPP remote UE.

In steps S603-S608, the UE-to-network relay will allocate the IP address for the non-IP remote UE and will inform this IP and user ID to the network and charging function to charge the non-IP remote UE for this data. In step S703, the UE-to-network relay would establish the PDN connection with the network on behalf of the non-IP remote UE. Through the PDN connection, a packet gateway (P-GW) would allocate and inform the IP address for the non-IP remote UE and would inform the IP address to the UE-to-network relay. In step S704, the UE-to-network relay would maintain the mapping between the L2 link with the non-IP remote UE and the IP address allocated by the network. The UE-to-network relay would also perform the message translation from the L2 link toward the network by using this IP address. In step S705, the UE-to-network relay would transmit a remote UE report which would include the ID and IP information of the non-IP remote UE to the MME. In step S706, the MME would forward the remote UE report to the SCEF. In step S707, the charging function would use this IP address contained in the remote UE report to charge the non-IP remote UE and not the relay. After the authentication process is to be completed, the UE-to-network relay will receive the Layer 2 message from the remote UE and will transparently forward the Layer 2 message to the network over this non-IP PDN connection.

In step S708, the UE-to-network relay would forward the D2D authorization request from the non-IP remote UE to the ProSe function by transmitting to the ProSe function an Authorization Request message which would include an ID of the non-IP remote UE and information related to the D2D service request. In step S709, the ProSe function will check the authentication with the home subscriber server (HSS). If the authorization is successful, the ProSe function will accept the non-IP remote UE for D2D communication. In step S710, the ProSe function would provide configuration details related to the D2D communication by transmitting configuration parameters to the UE-to-network relay. In step S711, the UE-to-network relay would transmit to the non-IP remote UE a Layer 2 connection accept message which would include configuration parameters for the D2D communication. In step S712, the UE-to-network relay would maintain a Layer 2 communication link with the non-IP remote UE. In step S713, the UE-to-network relay would relay IP based data traffic on behalf of the non-3GPP remote UE. In step S714, a new interface between SCEF and ProSe Function would be utilized to help the non-IP data traffic from UE-to-network the relay to be forwarded to the ProSe Function.

For devices with Non-IP capabilities, the new interface is for communication between a SCEF and a ProSe Function with functionalities to be implemented on ProSe function & SCEF. The new interface can be either an IP type or can use the RESTful APIs. The new interface will be used transparently to forward the non-IP PDN packets to the ProSe function based on the D2D service request. The new interface could be used for the service revocation or re-authorization proposes. The SCEF may map the ProSe function messages over non-IP PDN and forward the ProSe function message to the UE-to-network function. This new interface may operate in a similar way as the SCEF and the AS interface defined in the 3GPP TS 23.682.

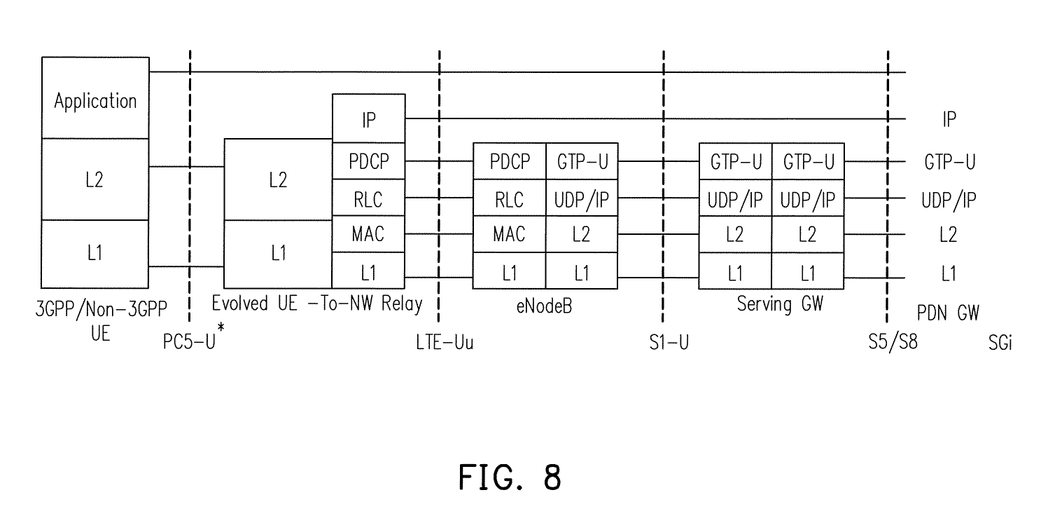

FIG. 8 illustrates a protocol structure for non-3GPP and non-IP devices in accordance with one of the exemplary embodiments of the disclosure. The UE-to-network relay will support the Layer 2 communication mechanism for all the supported access network which may include one of or both of 3GPP and 3GPP network. The UE-to-network relay will establish a PDN connection with the network on behalf of the remote UE and will maintain the mapping of Layer 2 link and the PDN connection with network. This mapping will be used to translate the UE packets over the Layer2 link to be sent to network by using the PDN connection which the UE-to-network relay has requested on behalf of the UE. The UE could be either a non-3GPP device or a non-IP device. The PC5-U* interface would include a Layer2 communication link interface between the UE-to-network relay and the UE which could be either a remote non 3GPP UE or a non-IP UE.

Overall, the disclosure provides implementable features to a UE-to-network relay and a ProSe UE function to support Layer 2 connectivity to the 3GPP and non-3GPP remote UE. For each connection request, the UE-to-network relay will request PDN connection with the network. UE-to-network relay will provide its capabilities which is broadcasted to UE devices. For the non 3GPP type of remote UE, the UE-to-network relay will request for the PDN connection. For the non IP type of devices, the relay will request for the non-IP PDN request. The UE-to-network relay will perform translations of Layer 2 request received from a remote UE towards network by using the PDN connection and vice versa. The UE-to-network relay will maintain the mapping until the end of the Layer 2 connection. The UE-to-network relay will send the authentication request on behalf of the remote UE and will accept the Layer 2 connection upon successful authentication with the ProSe function. In case the network revokes the authentication, the UE-to-network relay will inform the revocation to remote UE over Layer 2 and will remove the Layer 2 link with the remote UE.

In view of the aforementioned descriptions, the disclosure is suitable for being used in a wireless communication system and is able to allow non-3GPP and non-IP devices to connect to a LTE network and to engage in D2D communication through the LTE network.

No element, act, or instruction used in the detailed description of disclosed embodiments of the present application should be construed as absolutely critical or essential to the present disclosure unless explicitly described as such. Also, as used herein, each of the indefinite articles “a” and “an” could include more than one item. If only one item is intended, the terms “a single” or similar languages would be used. Furthermore, the terms “any of” followed by a listing of a plurality of items and/or a plurality of categories of items, as used herein, are intended to include “any of”, “any combination of”, “any multiple of”, and/or “any combination of multiples of the items and/or the categories of items, individually or in conjunction with other items and/or other categories of items. Further, as used herein, the term “set” is intended to include any number of items, including zero. Further, as used herein, the term “number” is intended to include any number, including zero.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A method used by a relay to connect a non-Third Generation Partnership Project (3GPP) or a non-Internet Protocol (IP) device to a Longer-Term Evolution (LTE)-based communication system, and the method comprising:
determining a plurality of radio interfaces supported by the relay;
configuring a broadcast message to be transmitted by including information related to the radio interfaces supported by the relay in the broadcast message;
transmitting the broadcast message on all radio channels associated with the radio interfaces supported by the relay; and
processing a Layer 2 connection request for a Layer 2 connection.

2. The method of claim 1, wherein the radio interfaces comprise a radio bearer, and information related to the radio interfaces comprise capabilities associated with the radio bearer of the radio interfaces.

3. The method of claim 2, wherein the radio interfaces comprise a LTE bearer, a Wi-Fi bearer, and a BT bearer, and the broadcast message includes all three of the LTE bearer, the Wi-Fi bearer, and the BT bearer in the information related to the radio interfaces.

4. The method of claim 1, wherein the Layer 2 connection request comprises an identification (ID), a service request, and a device type.

5. The method of claim 4, wherein the device type is either a non-3GPP device type or a non-IP device type.

6. The method of claim 1, wherein processing the Layer 2 connection request for the Layer 2 connection comprising:
transmitting a PDN connection request on behalf of a remote user equipment (UE);
processing the Layer 2 request received from the UE by using the PDN connection; and
receiving an Internet Protocol (IP) address from a network for the remote UE.

7. The method of claim 6, wherein the PDN connection request is a PDN connection for a non-3GPP type of remote UE and the PDN connection request is a non-IP PDN connection for a non-IP type of remote UE.

8. The method of claim 6, further comprising:
transmitting an authentication request to a ProSe function on behalf of the remote UE; and
granting Layer 2 connection request after the authentication request is successful.

9. The method of claim 8 further comprising:
transmitting a Layer 2 connection accept message which comprises a D2D configuration for the remote UE.

10. The method of claim 8 further comprising:
transmitting a Layer 2 connection denied message after the authentication request is revoked and severing the Layer 2 connection with the Remote UE.

11. The method of claim 10 further comprising:
maintaining a mapping relationship between the Layer 2 connection and a IP address until the layer 2 connection is ended.

12. A relay comprising:
a wireless transceiver; and
a processor connected to the transceiver and configured to:
determine a plurality of radio interfaces supported by the relay;
configure a broadcast message to be transmitted by including information related to the radio interfaces supported by the relay in the broadcast message;
transmit the broadcast message on all radio channels associated with the radio interfaces supported by the relay; and
process a Layer 2 connection request for a Layer 2 connection.

13. A method used by a non-3GPP or a non-IP user equipment (UE) to connect to a LTE-based communication system, and the method comprising:
receiving through a radio interface a broadcast message which comprises information related to a plurality of radio interfaces supported by a relay;
obtaining from the broadcast message the information related to the radio interfaces supported by the relay;
matching the information related to the radio interfaces supported by the relay with a network selection criteria of the UE; and
selecting one of the radio interfaces that matches the network selection criteria of the UE.

14. The method of claim 13 further comprising:
transmitting a Layer 2 connection request for a Layer 2 connection, and the Layer 2 connection request comprises a identification (ID) of the UE, a service request, and a device type.

15. The method of claim 14, wherein the device type is either a non-3GPP device type or a non-IP device type.

16. The method of claim 13 further comprising:
receiving a Layer 2 connection accept message which comprises a D2D configuration for the UE.

17. The method of claim 16 further comprising:
receiving a Layer 2 connection denied message after an authentication request is revoked as the Layer 2 connection is severed by a relay.

18. The method of claim 13, wherein the radio interfaces comprise a radio bearer, and information related to the radio interfaces comprise capabilities associated with the radio bearer of the radio interfaces.

19. The method of claim 18, wherein the radio interfaces comprise a LTE bearer, a Wi-Fi bearer, and a BT bearer, and the broadcast message includes all three of the LTE bearer, the Wi-Fi bearer, and the BT bearer in the information related to the radio interfaces.

20. A user equipment comprising:
a transceiver; and
a processor coupled to the transceiver and configured to:
receive through a radio interface a broadcast message which comprises information related to a plurality of radio interfaces supported by a relay;
obtain from the broadcast message the information related to the radio interfaces supported by the relay;
match the information related to the radio interfaces supported by the relay with a network selection criteria of the UE; and
select from the radio interfaces one radio interface that matches the network selection criteria of the UE.
